(19) United States
(12) Patent Application Publication
(10) Pub. No.: US 2008/0175112 A1
(43) Pub. Date: Jul. 24, 2008

(54) Automatic Backup System

(75) Inventors: Jacobus Maarten Den Hollander, Eindhoven (NL); Johannis Friso Rendert Bacquiere, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,766

(22) PCT Filed: Aug. 31, 2006
(86) PCT No.: PCT/IB2006/053032

§ 371 Date: Mar. 5, 2008

(30) Foreign Application Priority Data
Sep. 8, 2005 (EP) 05108244.4

(51) Int. Cl. G11B 19/02

(52) U.S. Cl. 369/47.12

(57) ABSTRACT

A recording system stores files on a removable, optical record carrier (11). The record carrier has an annular recording area corresponding to a logical data space accessible according to a predefined recording format. The recording system has a control unit (20) for controlling the recording means for storing the files in respective data blocks. A backup unit (32) stores at least one backup file of an original file, and assigns, to the backup file, backup blocks in the logical data space. The backup blocks (305,306,307) are physically positioned remote from corresponding original blocks (302,303,304) of the original file in the logical data space, e.g. by applying a predetermined radial shift. Hence the record carrier is provided with reliable data, wherein the backup blocks and the original blocks form a spatially distributed pattern for avoiding that local disturbances of the recording area affect corresponding blocks of the original blocks and backup blocks.

The invention relates to a recording system for storing files on a removable, optical record carrier, the record carrier having a track pattern constituting an annular shaped recording area, the recording area corresponding to a logical data space accessible according to a predefined recording format, the recording system having recording means for recording data blocks at physical locations in the track, and a control unit for controlling the recording means for storing the files in respective data blocks.

The invention further relates to a reading system for reading stored files on a removable, optical record carrier, the record carrier having a track pattern constituting an annular shaped recording area, the recording area corresponding to a logical data space accessible according to a predefined recording format, the reading system having reading means for reading data blocks at physical locations in the track, and a control unit for controlling the reading means for reading the files in respective data blocks.

The invention further relates to a record carrier of a removable, optical type, the record carrier having a track pattern constituting an annular shaped recording area, the recording area corresponding to a logical data space accessible according to a predefined recording format, the track having data blocks at physical locations, the data blocks constituting files.

The invention further relates to a method, and a computer program product, for storing files on a removable, optical record carrier.

The document US 2002/0188800 describes a self mirroring high performance disk drive. A disk drive system includes one or more platters, each platter supporting at least one recording surface, where the platters are aligned about a common central axis. The platters spin about the common central axis. A recording head is associated with each recording surface for recording on an annular shaped recording area. An actuator mechanism couples to each recording head to move the recording head into proximity with selected portions of the recording surface in response to received commands. Like the magnetic hard disk drive a CDROM or DVDROM also exhibit rotational latency. At least two replicates of data are stored in at least two data storage areas such that any one of the at least two replicates can be accessed to service a data access request for reducing rotational latency. The available recording area is reduced by assigning a section of the recording area to store the redundant copies, e.g. at 180 degrees rotational offset for a two-copy implementation. Also a mirroring about a central diameter may be performed to reduce seek time.

The mirroring requires that the recording area is subdivided in two annular zones. For mirroring copies are stored in both zones in mirrored locations with respect to a dividing boundary line between the zones. A problem of the mirroring in the known system is that the mirroring is automatic and results in a reduced data storage space of the record carrier to 50% or less, e.g. the CDROM will present a data storage area that is 50% the normal size for a two-copy implementation. Moreover, the zone reserved for the mirrored data blocks is not accessible for standard devices operating according to a standardized, predefined recording format. Also, switching to a redundant mode later requires reformatting of the record carrier.

It is an object of the invention to provide a storage system that accommodates flexible storage of redundant copies of data.

For this purpose, according to a first aspect of the invention, in the recording system as described in the opening paragraph, the control unit comprises a backup unit for storing at least one backup file of an original file, and for assigning, to the backup file, backup blocks in the logical data space, the backup blocks being physically positioned remote from corresponding original blocks of the original file in the logical data space, the backup blocks and the original blocks forming a spatially distributed pattern for avoiding that local disturbances of the recording area affect corresponding blocks of the original blocks and backup blocks.

For this purpose, according to a second aspect of the invention, in the reading system as described in the opening paragraph, the control unit comprises a backup unit for selectively reading backup blocks in the logical data space from at least one backup file of an original file, the backup blocks being physically positioned remote from corresponding original blocks of the original file in the logical data space, the backup blocks and the original blocks forming a spatially distributed pattern for avoiding that local disturbances of the recording area affect corresponding blocks of the original blocks and backup blocks.

For this purpose, according to a third aspect of the invention, on the record carrier as described in the opening paragraph, the files include at least one original file, and at least one backup file of the original file, and backup blocks in the logical data space have been assigned to the backup file, the backup blocks being physically positioned remote from corresponding original blocks of the original file in the logical data space, the backup blocks and the original blocks forming a spatially distributed pattern for avoiding that local disturbances of the recording area affect corresponding blocks of the original blocks and backup blocks.

The spatially distributed pattern is a pattern of stored original data blocks belonging to one or more original files, and corresponding backup blocks belonging to backup files. The distribution of the blocks is such that, in the physical recording area, there is a spatial distance in which the corresponding blocks are at least remote from each other at a minimum distance. The minimum distance is chosen to be sufficiently large to overcome common defects on the record carrier, e.g. scratches and surface disruptions. The measures according to the invention have the effect that the backup blocks are stored in the logical data space itself. The backup copy may be provided on a file by file basis. The reading system selectively reads the original file or the backup file, which improves the reliability of data storage for the files that are stored using the backup features. Advantageously there is no pre-assigned part of the recording area that is reserved for the copies. Hence the data capacity is only reduced up to the amount required by files that are stored using the backup features.

The invention is also based on the following recognition. Consumers appear to consider the removable, optical record carrier as a safe medium. Nevertheless, optical storage media are not always reliable in the sense that data can sometimes not be read back. The causes can be many; mechanical defects such as scratches or deformation (tilt), but also the quality of the materials used affect the data retention over time. As long as the data on optical disc is a copy of data that is still available, this is not more than just a nuisance but if the data on disc is essentially the only version of data that is no longer available elsewhere this is a serious problem. Hence the inventors have seen that a selective, automatic backup system, which provides backup copies on a file by file basis, obviates this problem to a large extent. In addition by accommodating the backup copy in the standard logical data space, the inventors provided a readout option, when required, by standard drives, which further increases the potential recovery of damaged files by a non technical consumer. Finally it has been noted that a record carrier having the backup system according to the invention advantageously provides a reliable read-only medium for distributing software. By providing critical files, or all files, on the read-only disk with corresponding backup files, the consumer will, even in the event of local physical damage, still be able to recover the files from the record carrier.

In an embodiment of the recording system the record carrier comprises at least one further recording layer parallel to a first recording layer for constituting the recording area, the recording layers being accessible for writing by an optical radiation beam via the same entry surface, and the backup unit is arranged for accommodating the backup blocks on a different recording layer with respect to the recording layer accommodating the corresponding original blocks. This has the advantage that, as the original and backup blocks are on different layers and at different positions, it is prevented that a local disturbance destroys corresponding blocks. Also, because corresponding blocks are on different layers, problems affecting layers differently like material deterioration probably will not affect corresponding blocks to a same extent.

In an embodiment of the recording system the backup unit is arranged for accommodating the spatially distributed pattern by positioning the backup blocks in free locations on at least a predetermined radial shift with respect to the corresponding original blocks. The predetermined shift is selected to be large enough for preventing common mechanical defect affecting the corresponding original and backup blocks. If the blocks at that distance are already occupied, a larger distance is selected until free locations are found. This has the advantage that backup copies can always be accommodated until all data storage locations are in use.

In an embodiment of the recording system the backup unit is arranged for, when said positioning based on the predetermined radial shift exceeds one boundary of the annular recording area, positioning the backup blocks with respect to the other boundary of the annular recording area, in a particular case the positioning of the backup blocks with respect to the other boundary further being based on an excess distance by which the one boundary is exceeded. Advantageously, by applying a wrap around system when the backup blocks positions exceed the boundary of the recording area, a maximum distance is maintained between original and backup blocks.

In an embodiment of the reading system the backup unit is arranged for, in the event of read errors, switching between reading a sequence of original blocks and reading a sequence of corresponding backup blocks, or vice versa, and, in the event of said switching, continuing reading the respective sequence. This has the advantage that when the read head has to jump to a new track due to a read error, no time is lost be jumping back to the original track, i.e. only one jump is required when a read error is encountered.

In an embodiment of the reading system the backup unit is arranged for, in the event of read errors in an original block and in a corresponding backup block, combining the data from the corresponding original and backup blocks by combining error correction data from the corresponding original and backup blocks. This has the effect, that in addition to selection either the original or the corresponding backup block, there is a further recovery option by combining the data from both blocks. This has the advantage that, even in the event that both original and backup blocks do have errors, the user data may be retrieved.

Further preferred embodiments of devices according to the invention are given in the appended claims, disclosure of which is incorporated herein by reference.

These and other aspects of the invention will be apparent from and elucidated further with reference to the embodiments described by way of example in the following description and with reference to the accompanying drawings, in which

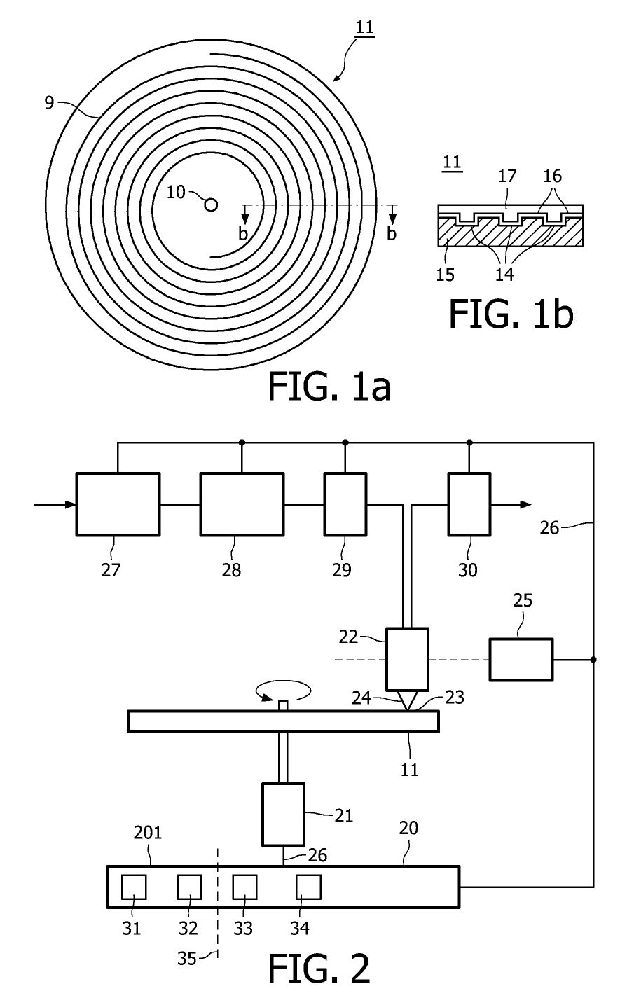

FIG. 1a shows a disc-shaped record carrier,

FIG. 1b shows a cross-section of the record carrier,

FIG. 2 shows a recording device having a backup system,

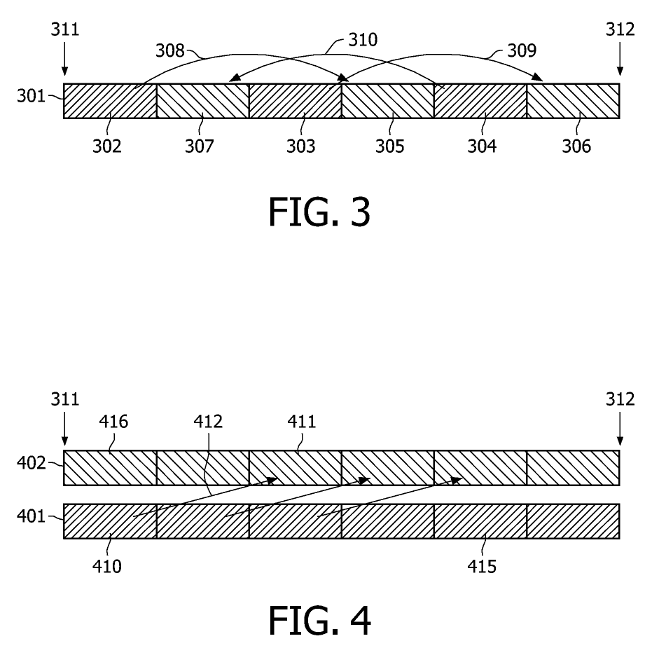

FIG. 3 shows a record carrier and stored original and backup files,

FIG. 4 shows a multilayer record carrier and stored original and backup files,

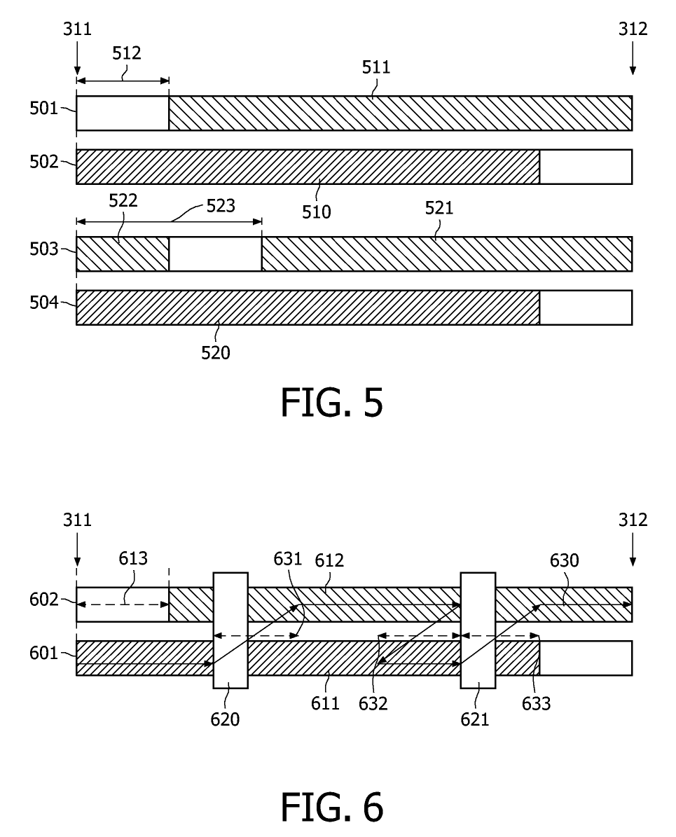

FIG. 5 shows two multilayer discs having a spatially distributed pattern, and

FIG. 6 shows reading data from a spatially distributed pattern.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier is of an optically readable type that is removable from a corresponding disk drive, like the well known CD or DVD, and has one or more information layers. The record carrier may be of a read-only type, e.g. for reliably distributing content or software, or of a recordable type, e.g. for reliably storing backup copies of files. Examples of recordable optical discs according to a predefined recording format are the CD-R, and rewritable optical disks like DVD+RW, and high density writable optical disc using blue lasers, called Blu-ray Disc (BD). Further details about the DVD disc can be found in reference: ECMA-267: 120 mm DVD—Read-Only Disc—(1997). The information is represented on the information layer by optically detectable marks along the track, e.g. pits or crystalline or amorphous marks in phase change material. The track 9 on the recordable type of record carrier is indicated by a pre-embossed track structure provided during manufacture of the blank record carrier. The track structure is constituted, for example, by a pregroove 14 in FIG. 1b which enables a read/write head to follow the track during scanning. The track structure comprises position information including so-called physical addresses, for indicating the location of units of information, usually called information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying digital information in information blocks having logical addresses in a logical data space under control of a file management system. The information blocks constituting a file are located according to file management data of a file management system, usually the file being subdivided in parts called extents. The extent accommodates a sequence of information blocks in a substantially consecutive range of addresses.

FIG. 2 shows a recording device having a backup system. The device is for writing information on a record carrier 11 of a type which is (re-)writable, as discussed with reference to FIG. 1. The device is provided with recording means for scanning the track on the record carrier which means include a drive unit 21 for rotating the record carrier 11, a head 22, a positioning unit 25 for positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an (optional) input unit 27, and a formatter 28 and a modulator 29. During the writing operation, marks representing the information are formed on the record carrier. The marks are formed by means of the spot 23 generated on the recording layer via the beam 24 of electromagnetic radiation, usually from a laser diode. Digital data is stored on the record carrier according to a predefined data format. Writing and reading of information for recording on optical discs and formatting, error correcting and channel coding rules are well-known in the art, e.g. from the CD and DVD system.

The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

The formatter 28 is for adding control data and formatting and encoding the data according to the recording format, e.g. by adding error correction codes (ECC), interleaving and channel coding. The formatted units comprise address information and are written to corresponding addressable locations on the record carrier under the control of control unit 20. The formatted data from the output of the formatter 28 is passed to the modulator 29, which generates a laser power control signal which drives the radiation source in the optical head. The formatted units presented to the input of the modulation unit 29 comprise address information and are written to corresponding addressable locations on the record carrier under the control of control unit 20.

The control unit 20 is arranged for controlling the recording, inter alia by locating each block at a physical address in the track. The control unit may include the following cooperating units: a file management unit 31 and a backup unit 32. The file management unit 31 is for managing the storage and retrieval of data files in the logical data space, and generating and updating file management data to be maintained on the record carrier, which is well known as such. The backup unit 32 is for creating a backup of data files according to the invention as explained below in detail. The control unit may contain further functional units, e.g. a real-time storage unit 33 and a defect management unit 34. The units are for example implemented in firmware or logical circuits in the control system of a disk drive.

In an embodiment the function of the file management unit 31 and the backup unit 32 are alternatively included in a control unit 201 in a separate device as indicated by dashed line 35. The functions may be performed as a process of data space management software, for example as a computer program in a host computer controlling a disc drive. Then the drive accommodates physically recording and retrieving of information in blocks on the record carrier.

In an embodiment the recording device is a storage device only, e.g. an optical disc drive for use in a computer. The control unit 20 is arranged to communicate with a processing unit in the host computer system via a standardized interface. Commands are processed in control unit 20, and digital data is communicated to the formatter 28 and the read processing unit 30.

In an embodiment the device is arranged as a stand alone unit, for example a video recording apparatus for consumer use. The control unit 20, or an additional host control unit included in the device, is arranged to be controlled directly by the user via a user interface (e.g. buttons and/or menus). The stand alone device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1, and for video in the MPEG2 standard. The input unit 27 processes the audio and/or video to units of information, which are passed to the formatter 28. The read processing unit 30 may comprise suitable audio and/or video decoding units.

The control unit 20 is arranged for translating physical addresses into logical addresses and vice versa in dependence of control data such as mapping information. The logical addresses constitute a contiguous user data storage space to be used for storing sequences of information blocks, such as files under control of a file management system, for example UDF (Universal Disc Format). The mapping information is indicative for translating a logical address in the logical data space to a physical address in the recording area, and may include defect management information.

The backup unit 32 is provided for providing a backup of data files stored on the record carrier. In general, when a backup is made, data is duplicated and stored on a physically different location to reduce the risk of loss. The solution provided now is store the backup copy on the disc itself. If the optical record carrier is used as a backup of other data, this results in a local backup of the backup. The aim of the backup copy is, to reduce the risk of data loss and hence increase the reliability of the medium. The backup unit 32 is functionally cooperating with the file management unit 31 for storing at least one backup file of an original file, and for assigning, to the backup file, backup blocks in the logical data space. The backup blocks are physically positioned radially remote from corresponding original blocks of the original file in the logical data space. The radial distance is set for being sufficiently remote for avoiding that local disturbances of the recording area affect corresponding blocks of the original blocks and backup blocks. Usually a few mm in radial direction will be sufficient, although a larger distance, up to 50% of the radial dimension of the annular recording area, may be preferred to maximize the reliability. When recovering data from a combination of the original file and the backup, such a maximized distance results in slower readout, hence in practice a radial shift (or offset) of 20% to 33% is preferred.

The position of the backup blocks may be selected arbitrarily in the remaining part of the recording area by skipping an annular part around the original blocks (i.e. applying the offset in two directions starting from the physical radial position of the original blocks), for example using the file management unit 31 to assign new free locations to a backup file and rejecting locations that are too close. As a result the backup blocks and the original blocks form a spatially distributed pattern as illustrated with FIGS. 3, 4 and 5.

FIG. 3 shows a record carrier and stored original and backup files. The Figure schematically shows a recording layer 301 having an annular recording area starting at inner radius 311 up to outer radius 312. In the Figure three files are shown: file1 302, file2 303 and file3 304, and respective backup copies copy1 305, copy2 306 and copy3 307. Note that usually on optical record carriers outer tracks (near the outer diameter) store more data blocks than inner tracks, and therefore the radial size of a copy at the outer position will be less than the radial size of the original at an inner position. The backup unit 32 is arranged for accommodating the spatially distributed pattern by positioning the backup blocks in free locations on at least a predetermined radial shift with respect to the corresponding original blocks. The radial shift is indicated by arrows 308,309,310. Hence, the file that is written on disc and its copy, are organized such that in case of a mechanical defect, typically a burst type defect, no unique data is lost. One way to do this is applying a radial shift that is larger than the common mechanical defects, e.g. having a width below 5 mm. A larger shift of 50% of the radial size of the recording area has been used in FIG. 3, and results in the spatially distributed pattern of data files as is shown. It is noted that also the original files may be positioned in a distributed pattern for forming free areas in between, so as to purposely create an interleaved pattern. In this way the data files and respective copies are located at different physical (radial) locations. Because mechanical defects are typically local, they give rise to a burst type behavior.

The data integrity is improved if the physical distance between original and copy is as large as possible. Note that different organizations of the data are possible as long as there is a minimal physical (radial) distance between the original and its copy being the radial distance covered one error correction frame, i.e. a number of data blocks being stored as a recordable unit sharing one set of error correction codes (ECC).

FIG. 4 shows a multilayer record carrier and stored original and backup files. In an embodiment the record carrier 11 is a multilayer record carrier as is shown in the Figure. The record carrier has at least one further recording layer 402 parallel to a first recording layer 401. Further recording layers may also be present. The stack of recording layers constitutes the recording area, the recording layers being accessible for writing by an optical radiation beam via the same entry surface. The Figure shows six data files (file1 to file6) on the first layer 401, and six backup copies (copy_of_file1 to copy_of_file6) on the second layer 402. The backup unit 32 accommodates the backup blocks 411 on the second recording layer 402 with respect to the first recording layer 401 accommodating the corresponding original blocks 410. Obviously the order may be reversed, or the blocks may be distributed across further different recording layers. On the dual layer disk one could use the strategy to place original and copy on the same layer as shown in FIG. 3, or use a strategy as is shown in FIG. 4, where the original is placed on one layer and the copy is placed on another layer.

In a further embodiment for a multilayer record carrier, the backup unit 32 is arranged for, when said positioning based on the predetermined radial shift exceeds one boundary of the annular recording area, positioning the backup blocks with respect to the other boundary of the annular recording area. In the example shown in FIG. 4 a radial shift in the direction of the outer radius 312 has been applied, the shift being substantially equal to ⅓ of the total radial size. For positioning the copy_of_file5 415 using said predetermined shift would position the copy outside the recording area beyond boundary of the outer radius 312. The position is selected by locating copy_of_file5 416 at the inner boundary 311, usually called wrap around. The positioning of the backup blocks with respect to the other boundary may be based on an excess distance by which the one boundary is exceeded, i.e. the excess distance is calculated and used to determine the wrap around position by adding the excess distance to the inner radius. Obviously the predetermined shift may alternatively be directed to the inner radius 311.

In a further embodiment the backup unit 32 is arranged for selecting opposite directions for the radial shift whenever appropriate for positioning the backup blocks. For example, where said positioning based on the predetermined radial shift exceeds one boundary of the annular recording area, the backup blocks are positioned at an opposite predetermined radial shift in opposite radial direction with respect to the corresponding original blocks.

FIG. 5 shows two multilayer discs having a spatially distributed pattern. The upper part shows a first recording layer 501 having a backup copy_of_file1 511, starting at a radial shift 512. The second recording layer 502 has the original file1 510, which is a relatively large file. The lower part shows a first recording layer 503 having a backup copy_of_file1 521, starting at a radial shift 523. The second recording layer 504 has the original file1 520. Note that the radial shift 523 is larger then the radial shift 512 in the upper example, and a final part 522 of the backup blocks is located at the other boundary. Hence, the backup unit 32 is arranged for, when the original file comprises a substantially contiguous sequence of original blocks on a recording layer, accommodating the backup blocks in a corresponding backup sequence on a different recording layer at a predetermined radial shift, and when said positioning based on the predetermined radial shift exceeds one boundary of the annular recording area, continuing the backup sequence at the other boundary of the annular recording area.

The recording system may have different operational modes. For each of the modes, or any combination thereof, the control unit 20 is arranged for selectively activating the backup unit for operating when required according to the specific mode. Note that the control unit, via the file management unit, also provides updating of file management data, e.g. by adding file entries in a special file folder named AutoBackup. In addition, note that the number of backup copies may also be selectable, e.g. two or three backup copies may be selected for very important data.

A first backup mode may automatically record a backup file when a command is received to record a file. In this mode every file that is recorded is provided with a backup copy. Alternatively the backup mode may selectively be activated, e.g. by a dedicated command to set the backup mode. Also, the backup mode may be indicated in the command for writing the original file, i.e. providing a mixed mode that creates backup copies only for files that have been marked. Note that, at the same time, several different files may be open for writing, and only some of those files may apply the automatic backup mode as set when opening the respective file.

The backup may directly be written after recording a series of original blocks, i.e. the contents of the blocks may still be available in a buffer memory and immediately are recorded again as backup copy. Alternatively, the backup may be created later, e.g. a separate command or by applying the background mode described now.

A second backup mode may be recording the backup files in a background process when no further operations are required. The control unit detects idle time, i.e. no commands are pending for execution, for executing the background process. The backup unit 32 manages a list of files and blocks that still need a backup copy. As soon as idle time is detected, the listed items are copied.

A third mode may be recording backup files on receiving a backup command from a user, or from a host computer. The backup command may indicate a selected file, or a set of files, or all files that have been recorded earlier. It is noted that such a command may also be executed for a record carrier that has been (partly) recorded already on a different recording device, e.g. a legacy recorder not able to perform the automatic backup copy. Also this mode may be executed in a background process.

A fourth mode may be a verify mode, and/or optionally a repair mode. The backup unit first verifies original blocks and corresponding backup blocks, and in the event of blocks showing read errors, reports the error status. A command may indicate a single file, a set of files or all files, to be verified and/or repaired. A repair mode may be selected, for, in the event of blocks showing read errors, recording further backup blocks for providing a required number of reliable copies of a blocks.

A read system is usually included in the recording device as shown in FIG. 2. Alternatively, a read-only system has similar elements as the recording system shown in FIG. 2, except for the specific recording elements, the input unit 27, formatter 28 and modulator 29. The read system has reading means including the optical head 22 and the read processing unit 30 for reading data blocks at physical locations in the track, and the control unit 20 for controlling the reading means for reading the files in respective data blocks, the control unit comprising the file management unit 31.

In the read system, the backup unit 32 has the function of selectively reading backup blocks in the logical data space from at least one backup file of an original file, i.e. recovering data from the original and backup blocks as described below. The backup unit will first detect the status of a record carrier, i.e. detect if backup copies are recorded, e.g. by searching for a standardized backup folder or backup status file containing such status information. For example, the backup status file may contain the parameters for easily locating the backup copies, e.g. the radial shift, or offset, and/or the specific parameters or files that have been used for providing backup copies. Correspondingly, when recording the backup copies, such backup folder or backup status file will be recorded. The read system may automatically detect the presence of backup files, and use them, or may be commanded to do so in a special safe reading mode, which may be a little slower due to additional read operations.

In the reading system, the backup unit may be arranged, when required to read a data block, to retrieve the data block from either the original file or the backup file, depending on whichever of the corresponding blocks is closest to the current position of the optical head. The backup unit is made aware of the physical positions of the original and corresponding backup blocks, and is arranged for purposely selecting the closest blocks when a read command is received. Hence the distance to be radially traveled by the head is reduced, and the combined reading mode will be faster.

In an embodiment of the reading system, the backup unit 32 is arranged for, in the event of read errors, switching between reading a sequence of original blocks and reading a sequence of corresponding backup blocks, or vice versa, and, in the event of said switching, continuing reading the respective sequence.

FIG. 6 shows reading data from a spatially distributed pattern. An original file1 611 is stored on a first recording layer 601, and a backup copy_of_file1 612 is stored on a second recording layer 602, applying a radial shift 613. In the example the record carrier has two defects 620,621 that interrupt the data at both recording layers. When arriving at the first defect 620, the backup unit 32 decides to continue reading on the copy_of_file1, and has to jump about the distance of the radial shift (or offset) as indicated by arrow 631. The reading continues on the second recording layer 602 until the second defect 621, and the backup unit requires the optical head to jump back as indicated by arrow 632. Finally, when again arriving at the second defect 621 (although now on the other layer), the reading is continued on the second layer as indicated by arrow 633. The total reading trajectory is indicated by multiple arrow set 630.

In an embodiment of the reading system the backup unit 32 is arranged for, in the event of read errors in an original block and in a corresponding backup block, combining the data from the corresponding original and backup blocks. Note that a number of data blocks are usually stored as a recordable unit sharing one set of error correction codes (ECC). The use of combined data further improves the reliability of data recovery in the event that both the data in the original file is erroneous as well as in the copy. The data that is partly corrected of the corresponding ECC frames can be combined in an attempt to reduce the number of erroneous symbols. The ECC algorithm may indicate that some parts of the data are indeed correct, where other parts within the frame still contain uncorrectable errors.

In addition, a combined error correction algorithm may be performed based on the combination of ECC symbols and data from both corresponding blocks. The combined ECC read mode is based on combining error correction data from the corresponding original and backup blocks. It is noted that, although the same data blocks are stored in original and corresponding backup blocks, further address location dependent scrambling may have been applied before storing the data, and some calculation is required to eliminate the effects of such scrambling before combining the data and ECC. For example, address location dependent scrambling and error correction algorithms are used in DVD as described in the DVD standard indicated above.

Although the invention has been explained mainly by embodiments using radial shift to accomplish the spatial distributed pattern, an angular shift may be applied also. Corresponding blocks may be positioned in angular remote patterns. This requires calculating the angular positions of the blocks, which depends on the actual parameters of the track pattern like track pitch and length of the blocks in the track. Such parameters may be known from a standard specification, or may be pre-recorded on the record carrier or may be measured by the disk drive. Furthermore, the examples are based on CD, or DVD dual layer record carriers, but any optical, removable record carrier is suitable for implementing the invention.

Further it is noted, that in this document the word ‘comprising’ does not exclude the presence of other elements or steps than those listed and the word ‘a’ or ‘an’ preceding an element does not exclude the presence of a plurality of such elements, that elements of the control unit discussed in the above may be present in hardware and/or software in different devices, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Recording system for storing files on a removable, optical record carrier (11), the record carrier having a track pattern (9) constituting an annular shaped recording area, the recording area corresponding to a logical data space accessible according to a predefined recording format,
the recording system having
recording means (22,25,28,29) for recording data blocks at physical locations in the track, and
a control unit (20,31) for controlling the recording means for storing the files in respective data blocks, the control unit comprising
a backup unit (32) for storing at least one backup file of an original file, and for assigning, to the backup file, backup blocks in the logical data space,
the backup blocks being physically positioned remote from corresponding original blocks of the original file in the logical data space,
the backup blocks and the original blocks forming a spatially distributed pattern for avoiding that local disturbances of the recording area affect corresponding blocks of the original blocks and backup blocks.

2. Recording system as claimed in claim 1, wherein the record carrier (11) comprises at least one further recording layer (402) parallel to a first recording layer (401) for constituting the recording area, the recording layers being accessible for writing by an optical radiation beam via the same entry surface, and the backup unit (32) is arranged for accommodating the backup blocks on a different recording layer with respect to the recording layer accommodating the corresponding original blocks.

3. Recording system as claimed in claim 1, wherein the backup unit (32) is arranged for accommodating the spatially distributed pattern by positioning the backup blocks in free locations on at least a predetermined radial shift with respect to the corresponding original blocks.

4. Recording system as claimed in claim 3, wherein the backup unit (32) is arranged for, when said positioning based on the predetermined radial shift exceeds one boundary of the annular recording area, positioning the backup blocks with respect to the other boundary of the annular recording area, in a particular case the positioning of the backup blocks with respect to the other boundary further being based on an excess distance by which the one boundary is exceeded.

5. Recording system as claimed in claim 3, wherein the backup unit (32) is arranged for, where said positioning based on the predetermined radial shift exceeds one boundary of the annular recording area, positioning the backup blocks at an opposite predetermined radial shift in opposite radial direction with respect to the corresponding original blocks.

6. Recording system as claimed in claim 2, wherein the backup unit (32) is arranged for, when the original file comprises a substantially contiguous sequence of original blocks on a recording layer, accommodating the backup blocks in a corresponding backup sequence on a different recording layer at a predetermined radial shift, and when said positioning based on the predetermined radial shift exceeds one boundary of the annular recording area, continuing the backup sequence at the other boundary of the annular recording area.

7. Recording system as claimed in claim 1, wherein the control unit (20) is arranged for selectively activating the backup unit for operating in at least one of the following modes:
a first mode for automatically recording a backup file when a command is received to record a file;
a second mode for recording the backup files in a background process when no further operations are required;
a third mode for recording backup files on receiving a backup command, for either a selected file or files, or for all files that have been recorded earlier;
fourth mode for verifying original blocks and corresponding backup blocks, and in the event of blocks showing read errors, reporting the error status and/or recording further backup blocks for providing a required number of copies of a block.

8. Reading system for reading stored files on a removable, optical record carrier (11), the record carrier having a track pattern (9) constituting an annular shaped recording area, the recording area corresponding to a logical data space accessible according to a predefined recording format,
the reading system having
reading means (22,30) for reading data blocks at physical locations in the track, and
a control unit (20,31) for controlling the reading means for reading the files in respective data blocks, the control unit comprising
a backup unit (32) for selectively reading backup blocks in the logical data space from at least one backup file of an original file,
the backup blocks being physically positioned remote from corresponding original blocks of the original file in the logical data space,
the backup blocks and the original blocks forming a spatially distributed pattern for avoiding that local disturbances of the recording area affect corresponding blocks of the original blocks and backup blocks.

9. Reading system as claimed in claim 8, wherein the backup unit (32) is arranged for, in the event of read errors, switching between reading a sequence of original blocks and reading a sequence of corresponding backup blocks, or vice versa, and, in the event of said switching, continuing reading the respective sequence.

10. Reading system as claimed in claim 8, wherein the backup unit (32) is arranged for, in the event of read errors in an original block and in a corresponding backup block, combining the data from the corresponding original and backup blocks by combining error correction data from the corresponding original and backup blocks.

11. Method for storing files on a removable, optical record carrier, the record carrier having a track pattern constituting an annular shaped recording area, the recording area corresponding to a logical data space accessible according to a predefined recording format,
the method comprising the steps of
controlling recording means for storing the files in respective data blocks at physical locations in the track, the recording area corresponding to a logical data space accessible according to a predefined recording format,
storing at least one backup file of an original file, and
assigning, to the backup file, backup blocks in the logical data space,
the backup blocks being physically positioned remote from corresponding original blocks of the original file in the logical data space,
the backup blocks and the original blocks forming a spatially distributed pattern for avoiding that local disturbances of the recording area affect corresponding blocks of the original blocks and backup blocks.

12. Computer program product for storing files on a removable, optical record carrier, the record carrier having a track pattern constituting an annular shaped recording area, the recording area corresponding to a logical data space accessible according to a predefined recording format, which program is operative to cause a processor to perform the method as claimed in claim 11.

13. Record carrier of a removable, optical type, the record carrier having a track pattern (9) constituting an annular shaped recording area, the recording area corresponding to a logical data space accessible according to a predefined recording format,
the track having data blocks at physical locations, the data blocks constituting files, the files including at least one original file, and at least one backup file of the original file, and backup blocks in the logical data space have been assigned to the backup file, the backup blocks being physically positioned remote from corresponding original blocks of the original file in the logical data space,
the backup blocks and the original blocks forming a spatially distributed pattern for avoiding that local disturbances of the recording area affect corresponding blocks of the original blocks and backup blocks.
